(19) United States
(12) Patent Application Publication
(10) Pub. No.: US 2016/0152167 A1
(43) Pub. Date: Jun. 2, 2016

(54) Instant Hot/Cold Seat

(71) Applicant: Eric Kozlowski, Oakland Township, MI (US)

(72) Inventor: Eric Kozlowski, Oakland Township, MI (US)

(21) Appl. No.: 14/931,877

(22) Filed: Nov. 4, 2015

Related U.S. Application Data
(60) Provisional application No. 62/074,798, filed on Nov. 4, 2014.

(51) Int. Cl. B60N 2/56

(52) U.S. Cl. CPC B60N 2/5692; B60N 2/5678; B60N 2/5621

(57) ABSTRACT

A heating and cooling mechanism is used in a seat assembly wherein the seat assembly includes a cellular foam pad encased by a trim cover. The mechanism includes a thermoelectric generator seated between the foam pad and the trim cover for generating heat in response to a first polarity of electrical power and generating cooling in response to a second polarity of electrical power opposite the first polarity of electrical power. A heat sink is coupled to the thermoelectric generator for dissipating heat generated by the thermoelectric generator and a fan coupled the heat sink for generating air flow to cool the mechanism. A skin layer of thermally conductive material is coupled to thermoelectric generator and seated between the foam pad and trim cover for providing uniform thermally conductive energy to the upper surface of the foam pad and trim cover.

### CROSS-REFERENCE TO RELATED APPLICATIONS

This application claims priority to and all the benefits of U.S. Provisional Application No. 62/074,798 filed on Nov. 4, 2014.

### BACKGROUND OF THE INVENTION

1. Field of the Invention

The present invention relates to a seat assembly in an automotive vehicle having a heating and cooling mechanism. More particularly, the invention relates to a thermoelectric mechanism for rapidly heating and cooling the surface of the seat assembly for seat occupant comfort.

2. Description of Related Art

Automotive vehicles include one or more seat assemblies having a seat cushion and a seat back for supporting a passenger or occupant above a vehicle floor. The seat assembly is commonly mounted to the vehicle floor by a riser assembly. The seat back is typically operatively coupled to the seat cushion by a recliner assembly for providing selective pivotal adjustment of the seat back relative to the seat cushion.

It is commonly known to provide automotive vehicle seat assemblies with heating and cooling mechanisms for selectively heating and cooling the surface of the seat for seat occupant comfort. These known heating and cooling mechanisms are typically independent mechanisms. For example, it is common to provide an electric wire heating pad between the foam pad and trim cover of the seat cushion or seat back which is electrically actuated by the power from the vehicle battery to electrically charge the heating pad and provide heat to the surface of the seat cushion or seat back. It is also known to provide fans and air ducts within the seat assembly to force cool air through the foam pad and trim cover and provide cool air to the surface of the seat cushion or seat back.

However, current heating and cooling mechanisms require a fair amount of time and power to generate sufficient heat or cool air to affect the temperature of the seat assembly, and thus, the desired comfort for the seat occupant.

It is desirable, therefore, to provide a heating and cooling mechanism which can rapidly or almost instantly provide heating or cooling to the surface of the seat assembly.

### SUMMARY OF THE INVENTION

A heating and cooling mechanism is provided for use in a seat assembly wherein the seat assembly includes a cellular foam pad at least partially encased by a trim cover. The mechanism includes a thermoelectric generator seated between the foam pad and the trim cover for generating heat in response to a first polarity of electrical power and generating cooling in response to a second polarity of electrical power opposite the first polarity of electrical power. A heat sink is coupled to the thermoelectric generator for dissipating heat generated by the thermoelectric generator and a fan coupled the heat sink for generating air flow to cool the mechanism.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a perspective view of a seat assembly for an automotive vehicle;

FIG. 2 is a perspective view of a bottom side of a seat cushion of the seat assembly showing a cellular foam pad encased in a trim cover with a thermoelectric mechanism according to one embodiment of the invention;

FIG. 3 is an enlarged view of the thermoelectric mechanism embedded in a channel of the foam pad;

FIG. 4 is perspective view of a thermoelectric generator and conductive skin layer;

FIG. 5 is another perspective view of the thermoelectric generator coupled to a heat sink and electric fan; and

FIG. 6 is a perspective view of the thermoelectric generator coupled to the conductive skin layer.

### DETAILED DESCRIPTION OF THE EMBODIMENTS

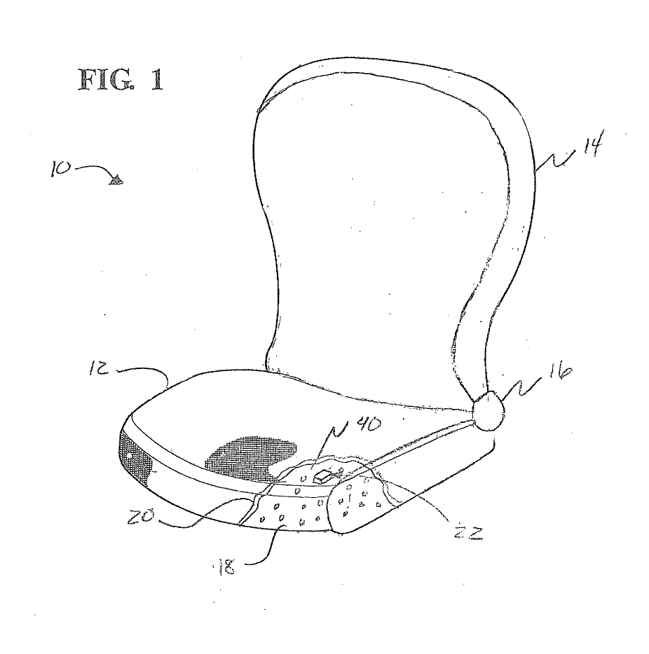

Referring to the Figures, wherein like numerals indicate like or corresponding parts throughout the several views, a seat assembly for use in an automotive vehicle is generally shown at 10 in FIG. 1 and includes a generally horizontal seat cushion 12 and a generally upright seat back 14 for supporting a seat occupant as is commonly known in the art. The seat back 14 is typically operatively coupled to the seat cushion by a recliner assembly 16 for providing pivotal movement between an upright seating position and a plurality of reclined seating positions.

Referring to FIGS. 1-3, each of the seat cushion 12 and seat back 14 include a molded resilient cellular foam pad 18 encased in a trim cover 20, commonly of cloth, vinyl, or leather. The present invention relates to a heating and cooling mechanism 22 operatively coupled to the seat cushion and/or seat back for selectively heating and cooling the surface of the seat assembly. More specifically, the heating and cooling mechanism 22 is a thermoelectric mechanism embedded in the foam pad 18 of either the seat cushion 12 or seat back 14 or between the top surface of the foam pad 18 and the bottom surface of the trim cover 20.

Referring to FIG. 6, the thermoelectric mechanism 22 includes a plurality of thermoelectric generators 24, or Peltier devices, spaced apart and fixedly secured to a thin skin layer of material 26. The skin layer 26 may include an aluminum, copper, graphene, graphite, or other thermally conductive layer of material. The skin layer 26 provides uniform thermoelectric conductive energy at a rate of approximately 100-200 watts/meter for aluminum or copper up to approximately 2000 watts/meter for graphene. Each thermoelectric generator 24 includes a positive and negative wire feed 28, 30 connected to a switch 32 and a power source 34, shown schematically in FIG. 6, for providing electrical current to the generator 24. As is known, providing current in one polarity to the thermoelectric generator 24 produces heat on one surface thereof and reversing the polarity produces cooling on one surface thereof. Thus, the thermoelectric generator 24 can provide rapid heating or cooling which is then spread about the surface of the conductive skin layer 26.

The skin layer 26 may be positioned between the upper surface of the foam pad 18 and the bottom surface of the trim cover 20 or, alternatively, embedded within the foam pad 18 at a predetermined distance below the upper surface thereof while still sufficient to supply heating or cooling to the surface of the seat 10.

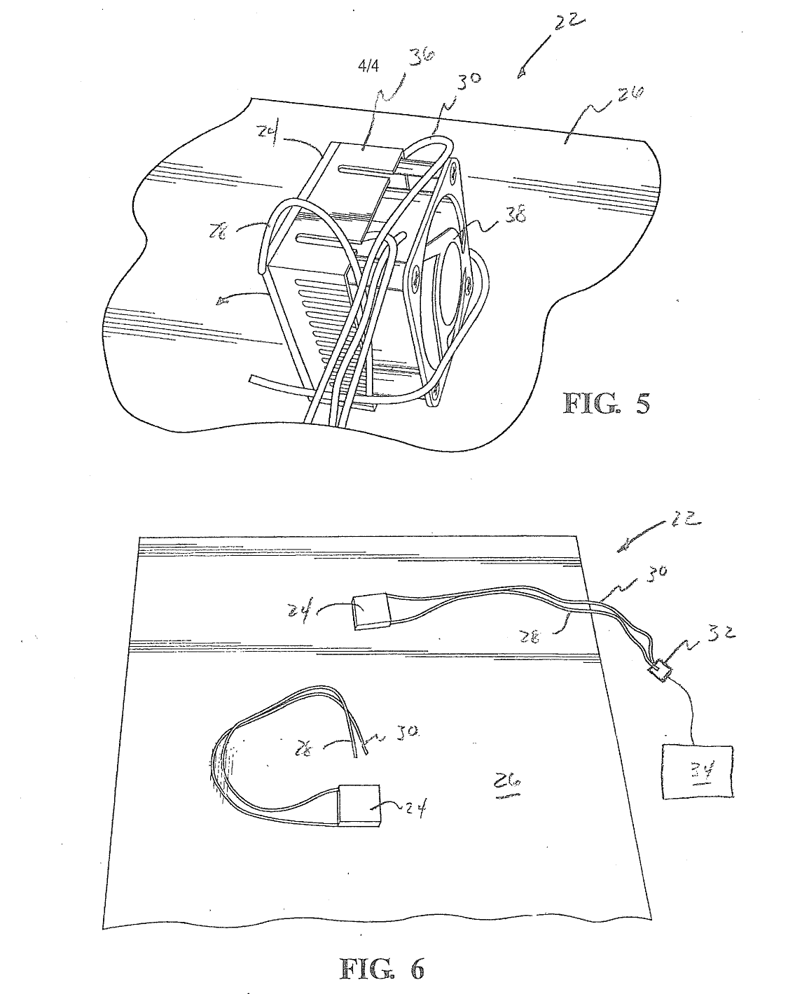

Referring to FIGS. 4 and 5, the thermoelectric mechanism 22 further includes a heat sink 36, typically of aluminum or copper material, fixedly secured to one side of the thermoelectric generator 24 for dissipating heat generated from the thermoelectric generator 24 and an electric fan 38 fixedly secured to the heat sink 36 for further cooling the mechanism 22. Alternatively, there are many other ways the heat generated by the thermoelectric mechanism 22 can be dissipated. One such way is to use two graphite skin layers 26 separated by an insulating material. The upper skin layer would heat or cool the seat surface as described above. The lower skin layer would dissipate the generated heat through the lower portion of the foam pad 18 and/or the remaining parts of the seat 10.

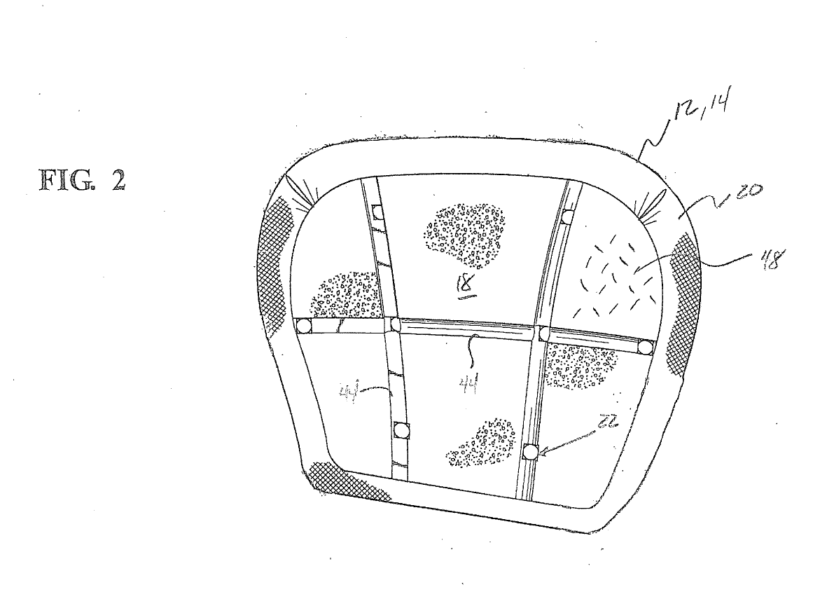

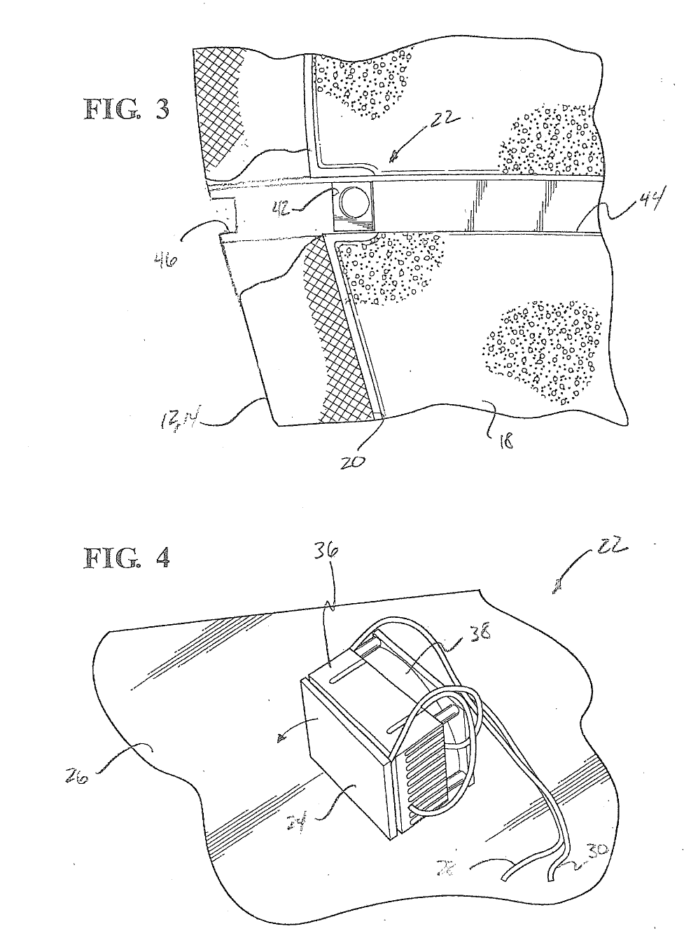

Finally, referring to FIGS. 2 and 3, the skin layer 26 including the attached plurality of thermoelectric generators 24, heat sinks 36, and fans 38, is shown embedded in the foam pad 18 either along the upper surface 40 thereof or slightly below the upper surface 40 of the foam pad 18 adjacent the lower surface of the trim cover 20. An opening 42 is formed in the foam pad 18 for each of the plurality of thermoelectric generators 25 to supply ambient air to the mechanism 22. Additionally, a series of channels 44 are formed in the foam pad 18 interconnecting each of the openings 42 to form an air flow channel through the foam pad 18 to allow the air to move or circulate in the foam pad 18 to remove heat from the seat assembly 10 to the atmosphere. That is, the heat generated by the thermoelectric mechanism 22 and the air flow created by the fan 38 to cool the thermoelectric generator 24 has to be able to circulate and move in the foam pad 18 to allow the heat to escape the seat assembly 10. At least one of the channels 44 formed in the foam pad 18 may further be connected to an air inlet opening 46 formed in the foam pad 18 to supply the air flow channels 44 with ambient air.

The thermoelectric mechanism 22 provides rapid and almost instantaneous heating or cooling to the seat assembly 10 with low power consumption. For example, the mechanism 22 requires approximately 60 watts of power to generate preferred heating and approximately 120 watts of power in reverse polarity to generate preferred cooling.

Finally, an alternative embodiment of the invention includes embedding particles of graphite or graphene 48 into the foam pad 18, shown schematically in FIG. 2, during molding thereof to act as the conductor of the heat from the thermoelectric mechanism 22 about a larger surface area without the need for the skin layer 26 of material. A foam pad 18 with conductive particles 48 embedded therein would provide flexibility in the placement of the thermoelectric mechanism 22 within the foam pad 18 adjacent the trim cover 20 and increase the conductive area of the foam pad 18 and trim cover 20.

The invention has been described in an illustrative manner, and it is to be understood that the terminology, which has been used, is intended to be in the nature of words of description rather than of limitation. Many modifications and variations of the present invention are possible in light of the above teachings. It is, therefore, to be understood that within the scope of the appended claims, the invention may be practiced other than as specifically described.

What is claimed is:

1. A heating and cooling mechanism for use in a seat assembly wherein the seat assembly includes a cellular foam pad at least partially encased by a trim cover, said heating and cooling mechanism including:
a thermoelectric generator seated between the foam pad and the trim cover for generating heat in response to a first polarity of electrical power and generating cooling in response to a second polarity of electrical power opposite the first polarity of electrical power;
a heat sink coupled to the thermoelectric generator for dissipating heat generated by the thermoelectric generator; and
a fan coupled the heat sink for generating air flow to cool the mechanism.

2. The mechanism as set forth in claim 1 wherein the thermoelectric generator includes a positive electrical wire feed and a negative electrical wire feed for providing the first and second polarity of electrical power to the thermoelectric generator.

3. The mechanism as set forth in claim 2 further include a switch operatively coupled to the thermoelectric generator for actuating the thermoelectric generator between the first and second polarities of electrical power and a power source coupled to the thermoelectric generator for providing the electrical power.

4. The mechanism as set forth in claim 3 wherein the foam pad includes an upper surface and a plurality of openings formed therein for receiving and supporting the heating and cooling mechanism thereby positioning the thermoelectric generator adjacent the upper surface of the foam pad adjacent the trim cover.

5. The mechanism as set forth in claim 4 wherein the foam pad includes a plurality of channels formed therein and intersecting the openings for providing air flow to the heating and cooling mechanism to dissipate heat from the seat assembly.

6. The mechanism as set forth in claim 6 wherein the foam pad further includes an air inlet opening in fluid communication with at least one of the channels for providing ambient air to the seat assembly.

7. The mechanism as set forth in claim 6 further including a skin layer of thermally conductive material coupled to the thermoelectric generator opposite the heat sink for producing a uniform thermoelectric conductive energy layer across the upper surface of the foam pad and adjacent the trim cover.

8. The mechanism as set forth in claim 7 wherein the skin layer may consist of aluminum, copper, graphene, graphite or other thermally conductive material.

9. The mechanism as set forth in claim 8 wherein the skin layer is sandwiched between the upper surface of the foam pad and the bottom surface of the trim cover.

10. The mechanism as set forth in claim 8 wherein the skin layer includes an upper skin layer, a lower skin layer and an insulating layer sandwiched therebetween, wherein the upper skin layer provides said thermoelectric energy to the bottom surface of the trim cover and the lower skin layer dissipates the energy through the foam pad and seat.

11. The mechanism as set forth in claim 6 wherein a plurality of thermally conductive particles are embedded throughout the foam pad to conduct heat from the thermoelectric generator throughout the foam pad.

12. The mechanism as set forth in claim 11 wherein the thermally conductive particles may consist of graphite or graphene.
